(19) United States
(12) Patent Application Publication
(10) Pub. No.: US 2022/0350910 A1
(43) Pub. Date: Nov. 3, 2022

(54) TECHNIQUES FOR SECURELY SHARING ACCESS TO DATA RECORDS

(71) Applicant: Cybernet Human LLC, Rapid City, SD (US)

(72) Inventors: Clay Strombeck, Rapid City, SD (US); Kelly McKinney, Rapid City, SD (US)

(73) Assignee: Cybernet Human LLC, Rapid City, SD (US)

(21) Appl. No.: 17/706,371

(22) Filed: Mar. 28, 2022

Related U.S. Application Data
(60) Provisional application No. 63/183,581, filed on May 3, 2021.

(51) Int. Cl. G06F 21/62; H04L 9/32

(52) U.S. Cl. CPC G06F 21/6218; H04L 9/3213

(57) ABSTRACT

Techniques for securely sharing access to data records are disclosed. In some implementations, an electronic device may receive a request for one or more data records, the request identifying one or more portions of the data records requested. The electronic device may access the one or more data records from an encrypted database. The electronic device may receive a selection one or more types of information of the one or more data records to redact. The electronic device may redact the one or more types of information of the one or more accessed data records. The electronic device may store the one or more redacted data records in the encrypted database. The electronic device may transmit the redacted data records to the entity requesting the one or more data records.

### CROSS REFERENCE TO RELATED APPLICATION

This application claims priority to U.S. provisional patent application Ser. No. 63/183,581, for “Techniques for Securely Sharing Access to Data Records” filed on May 3, 2021, which is hereby incorporated by reference in entirety for all purposes.

### FIELD

The present disclosure relates generally to data records, and in particular to techniques for securely sharing access to data records.

### BACKGROUND

Secure data records (e.g., medical records) can be securely stored in protected database. These records can be accessed by the data owners or those whom access has been granted (e.g., a primary care physician or medical facility). Circumstances exist where those records need to be shared with others who do not primarily have access. For example, if a patient become ill, or is injured while away from home, an emergency room physician may need access to the patient's records to help with treatment decisions. In some circumstances, the patient may be incapacitated or unable to recall their account access information such as their on-line records, and another designated individual (e.g., a spouse or family member) will need to grant access to these records to caregivers. The stored data records can also include privacy information (e.g., social security number, personal phone number, personal email address) that may not be required by caregivers. Electronic downloads of this information can contain such information in the electronic files. Inadvertent access to this information can lead to identity theft or other privacy related problems.

### SUMMARY

In some aspects, a method can include receiving a request for one or more data records. The request can identify one or more portions of the data records requested. The method can include accessing the one or more data records from an encrypted database. The method can include receiving a selection one or more types of information of the one or more data records to redact. The method can include redacting the one or more types of information of the one or more accessed data records. The method can include storing the one or more redacted data records in the encrypted database. The method can include generating an access token. The method can include sending the access token to an entity requesting the one or more data records.

In some aspects, the method includes sending a message to the entity requesting the one or more data records, wherein the message includes information on the one or more requested data records.

In some aspects, the method includes receiving a designation token to enable access to the one or more data records, the designation token identifying a user with permission to share one or more data records.

In some aspects, the access token comprises information to grant access permission to the one or more redacted data records.

In some aspects, the access token comprises information to identify the one or more redacted data records.

In some aspects, the access token expires after a defined time period.

In some aspects, the one or more types of information comprises one or more of: a social security number, a personal cell phone number, a home address, or a personal email address.

In some aspects, a method can include receiving a request for one or more data records. The request can identify one or more portions of the data records requested. The method can include accessing the one or more data records from an encrypted database. The method can include receiving a selection one or more types of information of the one or more data records to redact. The method can include redacting the one or more types of information of the one or more accessed data records. The method can include storing the one or more redacted data records in a memory of the electronic device. The method can include generating a message to an entity requesting the one or more data records, the message including the one or more redacted data records.

In some aspects, a format of the one or more data records is at least one of: a portable document format, a hypertext markup language format, and a JavaScript Object Notation format.

In some aspects, a method for providing access to secure data records includes: receiving a request for one or more data records, the request identifying one or more portions of the data records requested; accessing the one or more data records from an encrypted database;

receiving a selection one or more types of information of the one or more data records to redact; redacting the one or more types of information of the one or more accessed data records; storing the one or more redacted data records in a memory of the electronic device; and generating a message to an entity requesting the one or more data records, the message including an access code for one or more designated entities.

In some aspects, a non-transitory computer-readable medium storing a set of instructions includes: one or more instructions that, when executed by one or more processors of an electronic device, cause the electronic device to: receive a request for one or more data records, the request identifying one or more portions of the data records requested; access the one or more data records from an encrypted database; receive a selection one or more types of information of the one or more data records to redact; redact the one or more types of information of the one or more accessed data records; store the one or more redacted data records in the encrypted database; generate an access token; and send the access token to an entity requesting the one or more data records.

In some aspects, a non-transitory computer-readable medium storing a set of instructions includes: one or more instructions that, when executed by one or more processors of an electronic device, cause the electronic device to: receive a request for one or more data records, the request identifying one or more portions of the data records requested; access the one or more data records from an encrypted database; receive a selection one or more types of information of the one or more data records to redact; redact the one or more types of information of the one or more accessed data records; store the one or more redacted data records in a memory of the electronic device; and generate a message to an entity requesting the one or more data records, the message including the one or more redacted data records.

In some aspects, a non-transitory computer-readable medium storing a set of instructions includes: one or more instructions that, when executed by one or more processors of an electronic device, cause the electronic device to: receive a request for one or more data records, the request identifying one or more portions of the data records requested; access the one or more data records from an encrypted database; receive a selection one or more types of information of the one or more data records to redact; redact the one or more types of information of the one or more accessed data records; store the one or more redacted data records in a memory of the electronic device; and generate a message to an entity requesting the one or more data records, the message including an access code for one or more designated entities.

In some aspects, an electronic device includes: one or more memories; and one or more processors, communicatively coupled to the one or more memories, configured to: receive a request for one or more data records, the request identifying one or more portions of the data records requested; access the one or more data records from an encrypted database; receive a selection one or more types of information of the one or more data records to redact; redact the one or more types of information of the one or more accessed data records; store the one or more redacted data records in the encrypted database; generate an access token; and send the access token to an entity requesting the one or more data records.

In some aspects, an electronic device includes: one or more memories; and one or more processors, communicatively coupled to the one or more memories, configured to: receive a request for one or more data records, the request identifying one or more portions of the data records requested; access the one or more data records from an encrypted database; receive a selection one or more types of information of the one or more data records to redact; redact the one or more types of information of the one or more accessed data records; store the one or more redacted data records in a memory of the electronic device; and generate a message to an entity requesting the one or more data records, the message including the one or more redacted data records.

In some aspects, an electronic device includes: one or more memories; and one or more processors, communicatively coupled to the one or more memories, configured to: receive a request for one or more data records, the request identifying one or more portions of the data records requested; access the one or more data records from an encrypted database; receive a selection one or more types of information of the one or more data records to redact; redact the one or more types of information of the one or more accessed data records; store the one or more redacted data records in a memory of the electronic device; and generate a message to an entity requesting the one or more data records, the message including an access code for one or more designated entities.

These and other embodiments of the disclosure are described in detail below. For example, other embodiments are directed to systems, devices, and computer readable media associated with methods described herein.

A better understanding of the nature and advantages of embodiments of the present disclosure may be gained with reference to the following detailed description and the accompanying drawings.

### BRIEF DESCRIPTION OF THE DRAWINGS

FIG. 1 illustrates an overview of a system for securely sharing data records.

FIG. 2 illustrates an exemplary flow for a process for securely sharing data records.

FIG. 3 illustrates a first exemplary process for securely sharing data records.

FIG. 4 illustrates a second exemplary process for securely sharing data records.

FIG. 5 illustrates a third exemplary process for securely sharing data records.

FIG. 6 illustrates a fourth exemplary process for securely sharing data records.

FIG. 7 illustrates a first exemplary flow for a process for securely sharing data records.

FIG. 8 illustrates a second exemplary flow for a process for securely sharing data records.

FIG. 9 illustrates a third exemplary flow for a process for securely sharing data records.

FIG. 10 illustrates an exemplary embodiment of an electronic device.

### DETAILED DESCRIPTION OF THE DRAWINGS

The following detailed description of example implementations refers to the accompanying drawings. The same reference numbers in different drawings may identify the same or similar elements.

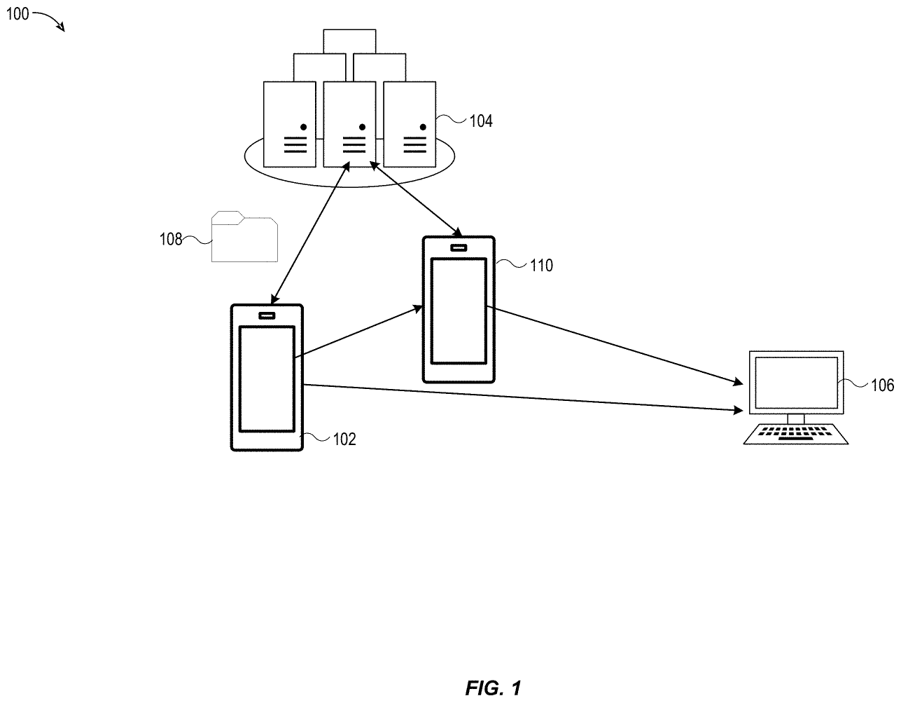

FIG. 1 illustrates an overview of a system 100 for securely sharing data records. The system 100 can include an electronic device 102, a database 104, and one or more recipient computer devices 106. The electronic device 102 can be a mobile device such a smartphone, a tablet computer or a laptop computer. The database 104 can be encrypted. The database 104 can store one or more records 108 (e.g., medical or dental records). The record 108 can include Extensible Markup Language (XML) including metadata XML. Extensible Markup Language is a markup language that defines a set of rules for encoding documents in a format that is both human-readable and machine-readable. In various embodiments, the database 104 can employ commercial software to protect the information. In various embodiments, the commercial software can include XpressRules' Consent Guard. The commercial software can allow the patient, using natural language (NL), to enact a smart “proxy” to restrict the record's release, access and use by third parties. The commercial software can enact a virtual “referee” that interprets your consent language to determine how the records 108 (e.g., health information) will be shared. In various embodiments, the consent policy can be employed using Extensible Access Control Markup Language (XACML). In various embodiments, the expression of consent can be provided using JavaScript Object Notation (JSON). In various embodiments, the commercial software can provide audits for requests for the records 108. In various embodiments, the commercial software can provide receipts for consent provided.

In various embodiments, a user (e.g., a patient) can access a record 108 through a network (e.g., the Internet). The user can interact with an Application (App) to share the record 108. The user can share the record 108 with one or more healthcare providers through the one or more recipient computer devices 106. In various embodiments, the user can provide access to the record 108 via one or more techniques. In a first technique, the user can download the record 108 via a network (e.g., the Internet). The user can select one or more formats for sharing the record 108 with a recipient (e.g., a healthcare provider). The format for the record 108 can include at least one of a portable document (pdf) format, a hypertext markup language (html) format, and a JavaScript Object Notation (JSON) format. In a second technique, the record 108 can be downloaded and pre-approved offline for sharing. In a third technique, a user can provide a token pass to a recipient (e.g., a healthcare provider). The recipient can use the token to access the record 108.

In various embodiments in a fourth technique, a user can designate a third party (e.g., a spouse or family member) permission to provide consent to share a record 108 for the user with one or more healthcare providers through the one or more recipient computer devices 106. In various embodiments, the user can designate the third party through an App on the electronic device 102. In various embodiments, the user can also remove the designation of the third party through an App on the electronic device 102. In various embodiments, the third party can receive a notification of the designation by the user. In various embodiments, the third party can share the record 108 through an App on a second electronic device 110. The second electronic device 110 can access the record 108 through a network (e.g., the Internet).

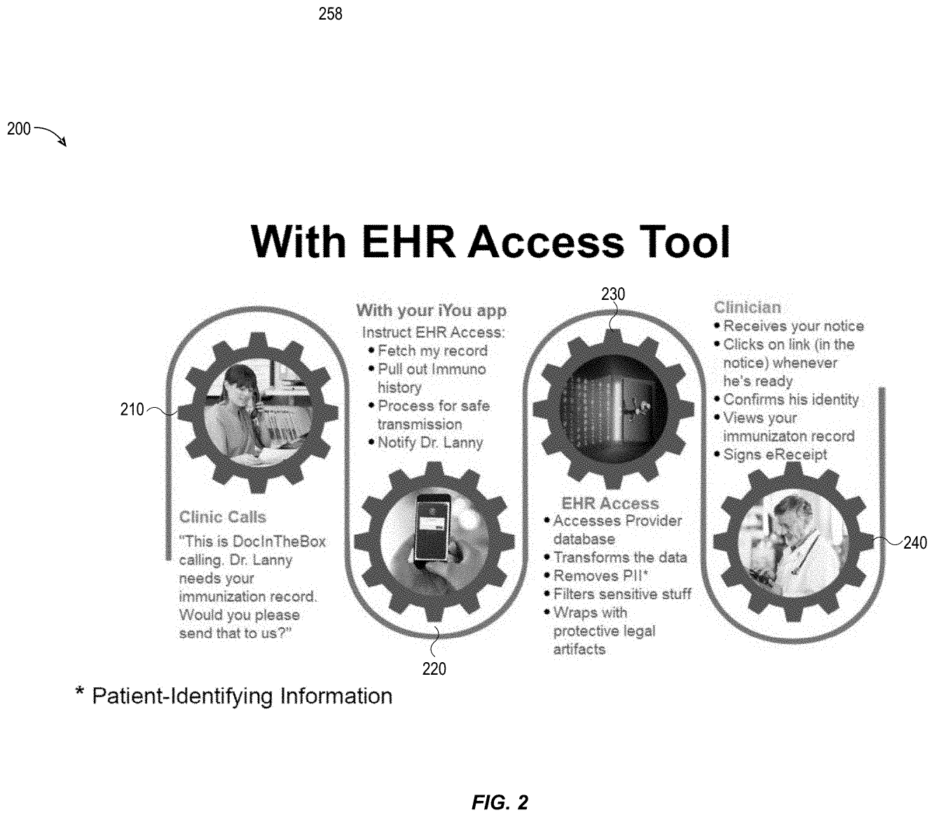

FIG. 2 illustrates an exemplary flow for a process 200 for securely sharing data records. At 210, an entity (e.g., a healthcare provider) can request all or part of a user's (e.g., a patient) medical record. At 220, a user can use an App to access a record (e.g., a medical record). The user can select all or a portion of the record to share (e.g., an immunization record). The record can be prepared for transmission. The App can notify the recipient (e.g., the healthcare provider) that the record has been shared.

At 230, the App can access the secure database. The App can transform the data into a format that can be shared. The App can remove or redact any confidential information (e.g., patient identifying information (PII)). The confidential information can include but is not limited to social security number, cell phone number, email address, and mailing address. The App can also filter other types of sensitive information. The App can wrap the record in protective legal artifacts prior to transmission to the requestor 314. The App can transmit the record or a token providing access to the record to the requestor 314 via a wired or wireless means via a network (e.g., the Internet).

At 240, the requestor (e.g., requesting healthcare provider) can receive a message with a link to the record. The requestor 314 can provide security credentials, confirming his or her identity. The Requestor 314 can execute a confirmation message (e.g., an eReceipt) confirming receipt of electronic delivery of the record. The receipt can be transmitted to the user via a network (e.g., the Internet).

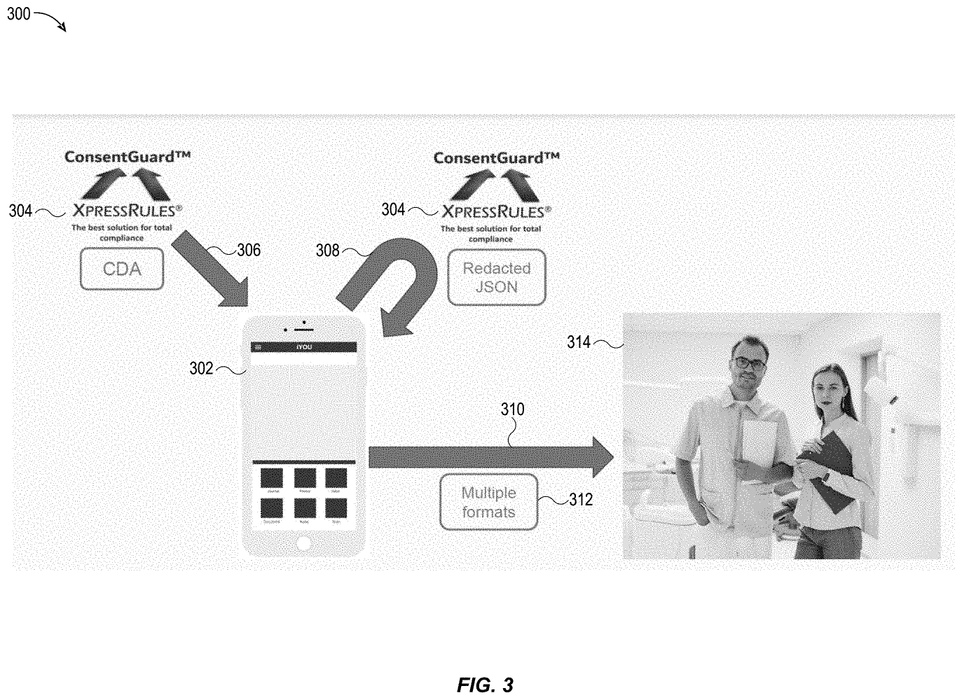

FIG. 3 illustrates a first exemplary process 300 for securely sharing data records. In an example, the electronic device 302 can access the medical record via an App. The record can be accessed from a secure database using commercially available security software 304 (e.g., ConsentGuard). The user can select all or a portion of the medical record that is to be shared. At 306, the security software 304 can send all or a portion of the medical record to the electronic device 302.

At 308, the App can receive a selection of the information that a user would like redacted. In various embodiments, certain types of information can be automatically redacted. In various embodiments, the record can be a redacted JSON.

At 310, the App can transmit the record or the redacted record to the Requestor 314. The record can be transmitted in any one of multiple formats 312. Advantages of the first exemplary process 300 can include that the Requestor 314 does not need to have an App to receive the records. Another advantage is that the records can be converted to any one of a multiple different formats 312. A disadvantage of the first exemplary process 300 is that the App requires Internet access and does not provide for pre-approval for sharing records.

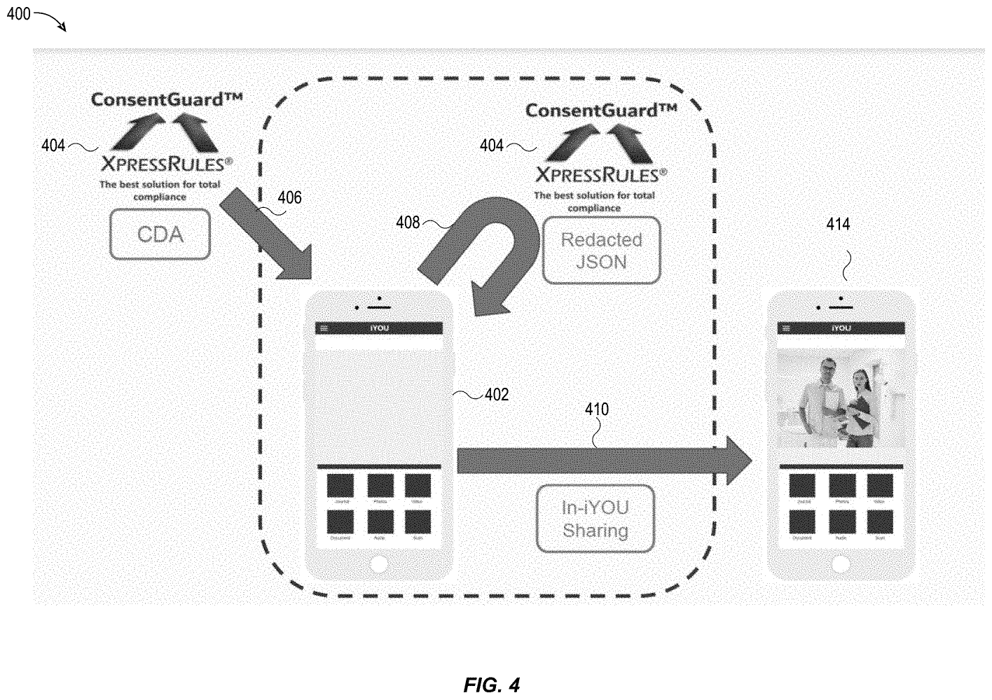

FIG. 4 illustrates a second exemplary process 400 for securely sharing data records. In an example, the electronic device 402 can access the medical record via an App. The record can be accessed from a secure database using commercially available security software 404 (e.g., ConsentGuard). The user can select all or a portion of the medical record that is to be shared. At 406, the security software 404 can send all or a portion of the medical record to the electronic device 402. The medical record can be stored in a memory of the electronic device 402.

At 408, the App can receive a selection of the information that a user would like redacted. In various embodiments, certain types of information can be automatically redacted. In various embodiments, the record can be a redacted JSON.

At 410, the App can share the record or the redacted record to the Requestor 314 (e.g., medical service provider) via an App. In the second exemplary process 400, the Requestor 314 also has an App and is able to receive the record via access to the App.

Advantages of the second exemplary process 400 can include allowing for pre-approval of Requestor 414 in the case of incapacitation of the user. As the record is stored in a memory of the electronic device 402, the record can be accessed offline. In the second exemplary process 400 the Requestor 314 can also use the App to access the records.

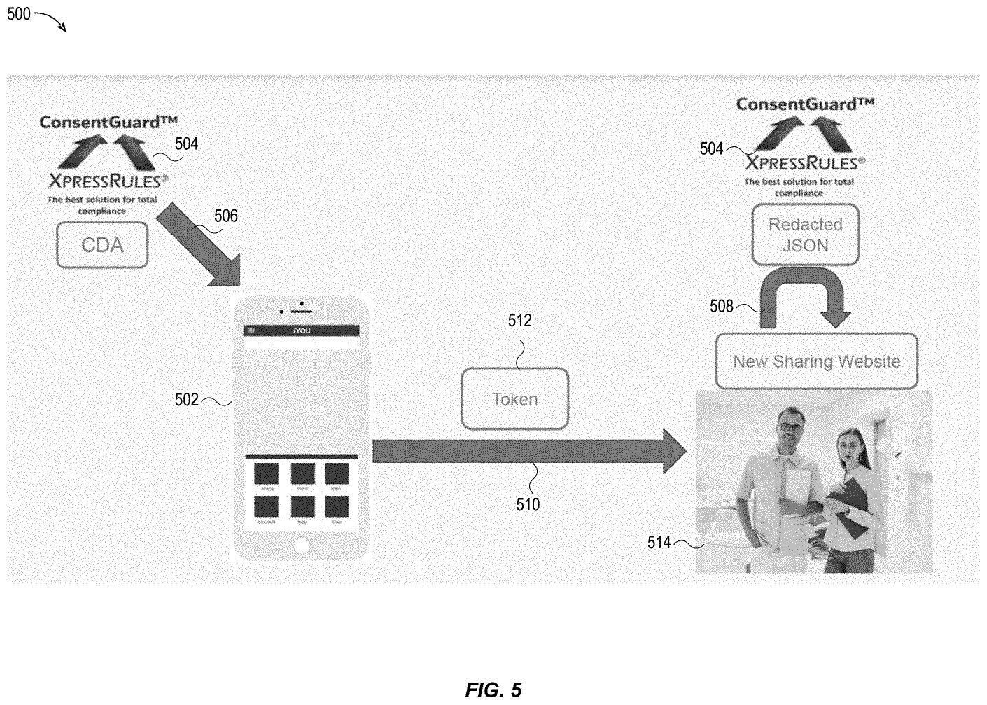

FIG. 5 illustrates a third exemplary process 500 for securely sharing data records. In an example, the electronic device 502 can access the medical record via an App. The record can be accessed from a secure database using commercially available security software 504 (e.g., ConsentGuard). The user can select all or a portion of the medical record that is to be shared. At 506, the security software 504 can send all or a portion of the medical record to the electronic device 502.

At 508, the process 500 can receive a selection of the information that a user would like redacted. In various embodiments, certain types of information can be automatically redacted. In various embodiments, the record can be a redacted JSON.

At 510, the App can generate a token 512 to be sent to the Requestor 514. The token can identify the medical records and provide permissions for a third party to access the medical record or redacted portion of the medical record through a network (e.g., the Internet). In various embodiments, the token 512 can expire after a predetermined amount of time. In various embodiments, a user can de-authorize access for the token 512. Therefore, the Requestor 514 would need access to the network to obtain access to the records.

An advantage of the third exemplary process 500 can be that the Requestor 514 does not need to use the App. Another advantage of the third exemplary process 500 is that the system can allow for pre-approval by transmitting the token prior to access being required.

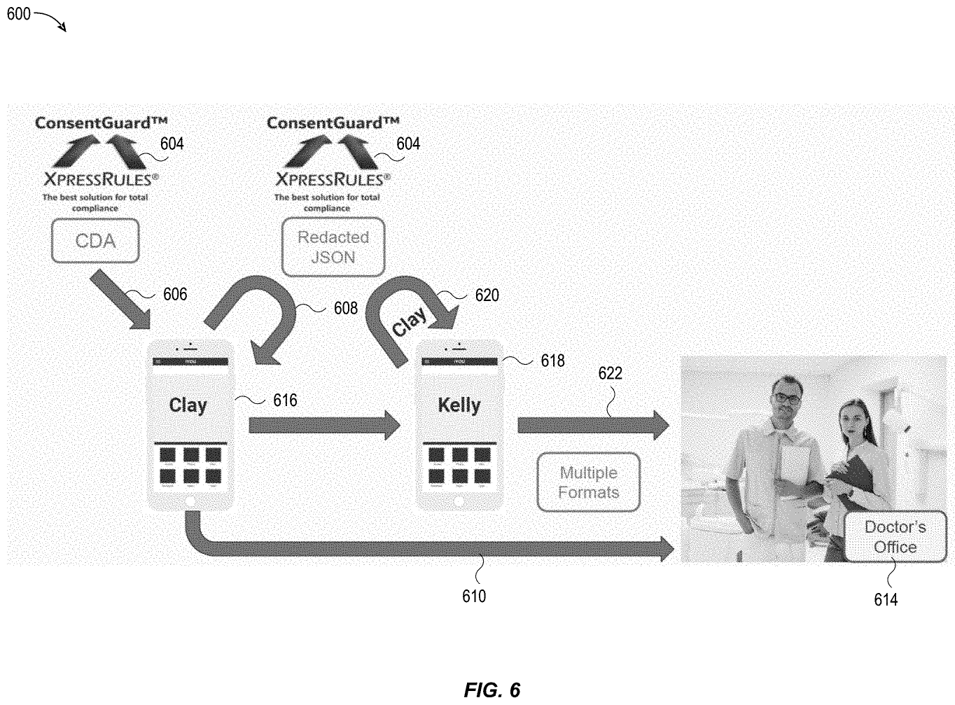

FIG. 6 illustrates a fourth exemplary process 600 for securely sharing data records. In an example, the electronic device 602 can access the medical record via an App. The record can be accessed from a secure database using commercially available security software 604 (e.g., ConsentGuard). The user can select all or a portion of the medical record that is to be shared. At 606, the security software 604 can send all or a portion of the medical record to the electronic device 602.

At 608, the App can receive a selection of the information that a user would like redacted. In various embodiments, certain types of information can be automatically redacted. In various embodiments, the record can be a redacted JSON.

At 610, the App can transmit the record or the redacted record to the Requestor 614. The record can be transmitted in any one of multiple formats.

At 616, a user can authorize a second user to securely share the records for the first user. In various embodiments, a first user can authorize or designate a second user access to the secure records. This access can include the ability to send the secure records to a Requestor 614 (e.g., a medical provider). In an example, the second electronic device 618 can access the medical record via an App. The record can be accessed from a secure database using commercially available security software 604 (e.g., ConsentGuard). The second user, via the second electronic device 618 can select all or a portion of the medical record that is to be shared. The security software 604 can send all or a portion of the medical record to the second electronic device 618.

At 620, the App can receive a selection of the information that a second user would like redacted. In various embodiments, certain types of information can be automatically redacted. In various embodiments, the record can be a redacted JSON.

At 622, the App in the second mobile device 618 can transmit the record or the redacted record to the Requestor 614. The record can be transmitted in any one of multiple formats.

Advantages of the fourth exemplary process 600 for securely sharing data records include that the techniques allow for pre-approval of sharing with secured individuals (e.g., spouse, child, or family members, or friends). Another advantage of the fourth exemplary process 600 is that the Recipients 614 do not need to have an App to receive the records. The fourth exemplary process 600 is also flexible in that it allows for flexible sharing in multiple different formats (e.g., pdf, html, json, etc.). In addition, the recipient and user do not need to access another website.

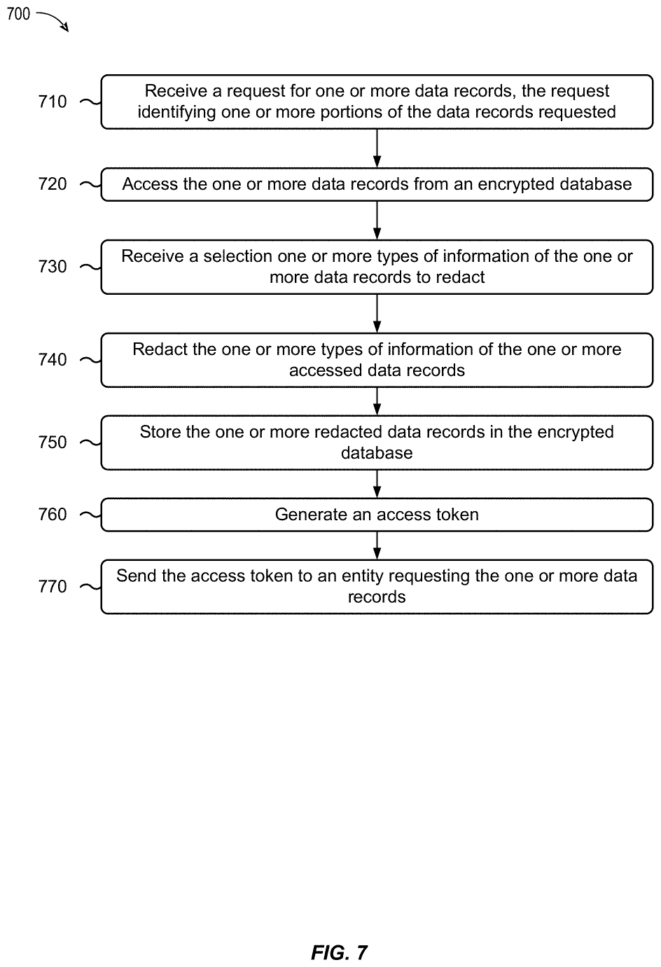

FIG. 7 is a flowchart of an example process 700 associated with techniques for securely sharing access to data records. In some implementations, one or more process blocks of FIG. 7 may be performed by an electronic device (e.g., electronic device 1000). In some implementations, one or more process blocks of FIG. 7 may be performed by another device or a group of devices separate from or including the electronic device. Additionally, or alternatively, one or more process blocks of FIG. 7 may be performed by one or more components of device 1000, such as processor 1018, computer readable medium 1002, Input/Output subsystem, 1006 and/or wireless circuitry 1008.

As shown in FIG. 7, process 700 may include receiving a request for one or more data records, the request identifying one or more portions of the data records requested (block 710). For example, the electronic device may receive a request for one or more data records, the request identifying one or more portions of the data records requested, as described above.

As further shown in FIG. 7, process 700 may include accessing the one or more data records from an encrypted database (block 720). For example, the electronic device may access the one or more data records from an encrypted database, as described above.

As further shown in FIG. 7, process 700 may include receiving a selection one or more types of information of the one or more data records to redact (block 730). For example, the electronic device may receive a selection one or more types of information of the one or more data records to redact, as described above.

As further shown in FIG. 7, process 700 may include redacting the one or more types of information of the one or more accessed data records (block 740). For example, the electronic device may redact the one or more types of information of the one or more accessed data records, as described above.

As further shown in FIG. 7, process 700 may include storing the one or more redacted data records in the encrypted database (block 750). For example, the electronic device may store the one or more redacted data records in the encrypted database, as described above.

As further shown in FIG. 7, process 700 may include generating an access token (block 760). For example, the electronic device may generate an access token, as described above.

As further shown in FIG. 7, process 700 may include sending the access token to an entity requesting the one or more data records (block 770). For example, the electronic device may send the access token to an entity requesting the one or more data records, as described above.

Process 700 may include additional implementations, such as any single implementation or any combination of implementations described below and/or in connection with one or more other processes described elsewhere herein.

In a first implementation, process 700 includes sending a message to the entity requesting the one or more data records, wherein the message includes information on the one or more requested data records.

In a second implementation, alone or in combination with the first implementation, process 700 includes receiving a designation token to enable access to the one or more data records, the designation token identifying a user with permission to share one or more data records.

In a third implementation, alone or in combination with one or more of the first and second implementations, the access token comprises information to grant access permission to the one or more redacted data records.

In a fourth implementation, alone or in combination with one or more of the first through third implementations, the access token comprises information to identify the one or more redacted data records.

In a fifth implementation, alone or in combination with one or more of the first through fourth implementations, the access token expires after a defined time period.

In a sixth implementation, alone or in combination with one or more of the first through fifth implementations, the one or more types of information comprises one or more of a social security number, a personal cell phone number, a home address, or a personal email address.

Although FIG. 7 shows example blocks of process 700, in some implementations, process 700 may include additional blocks, fewer blocks, different blocks, or differently arranged blocks than those depicted in FIG. 7. Additionally, or alternatively, two or more of the blocks of process 700 may be performed in parallel.

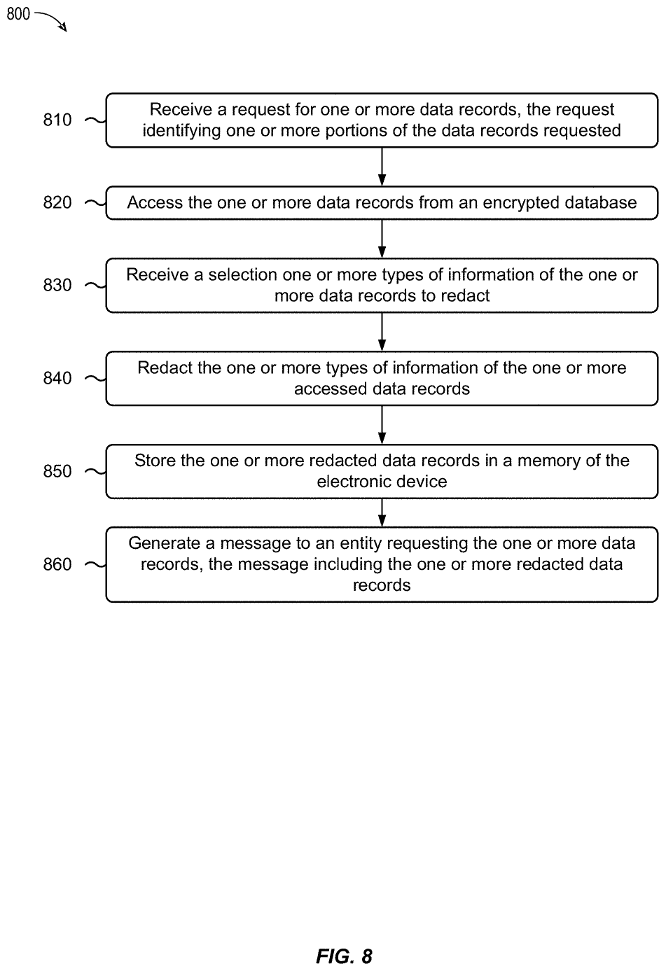

FIG. 8 is a flowchart of an example process 800 associated with techniques for securely sharing access to data records. In some implementations, one or more process blocks of FIG. 8 may be performed by an electronic device (e.g., electronic device 1000). Additionally, or alternatively, one or more process blocks of FIG. 8 may be performed by one or more components of device 1000, such as processor 1018, computer readable medium 1002, Input/Output subsystem, 1006 and/or wireless circuitry 1008.

As shown in FIG. 8, process 800 may include receiving a request for one or more data records, the request identifying one or more portions of the data records requested (block 810). For example, the electronic device may receive a request for one or more data records, the request identifying one or more portions of the data records requested, as described above.

As further shown in FIG. 8, process 800 may include accessing the one or more data records from an encrypted database (block 820). For example, the electronic device may access the one or more data records from an encrypted database, as described above.

As further shown in FIG. 8, process 800 may include receiving a selection one or more types of information of the one or more data records to redact (block 830). For example, the electronic device may receive a selection one or more types of information of the one or more data records to redact, as described above.

As further shown in FIG. 8, process 800 may include redacting the one or more types of information of the one or more accessed data records (block 840). For example, the electronic device may redact the one or more types of information of the one or more accessed data records, as described above.

As further shown in FIG. 8, process 800 may include storing the one or more redacted data records in a memory of the electronic device (block 850). For example, the electronic device may store the one or more redacted data records in a memory of the electronic device, as described above.

As further shown in FIG. 8, process 800 may include generating a message to an entity requesting the one or more data records, the message including the one or more redacted data records (block 860). For example, the electronic device may generate a message to an entity requesting the one or more data records, the message including the one or more redacted data records, as described above.

Process 800 may include additional implementations, such as any single implementation or any combination of implementations described below and/or in connection with one or more other processes described elsewhere herein.

In a first implementation, a format of the one or more data records is at least one of a portable document format, a hypertext markup language format, and a JavaScript Object Notation format.

Although FIG. 8 shows example blocks of process 800, in some implementations, process 800 may include additional blocks, fewer blocks, different blocks, or differently arranged blocks than those depicted in FIG. 8. Additionally, or alternatively, two or more of the blocks of process 800 may be performed in parallel.

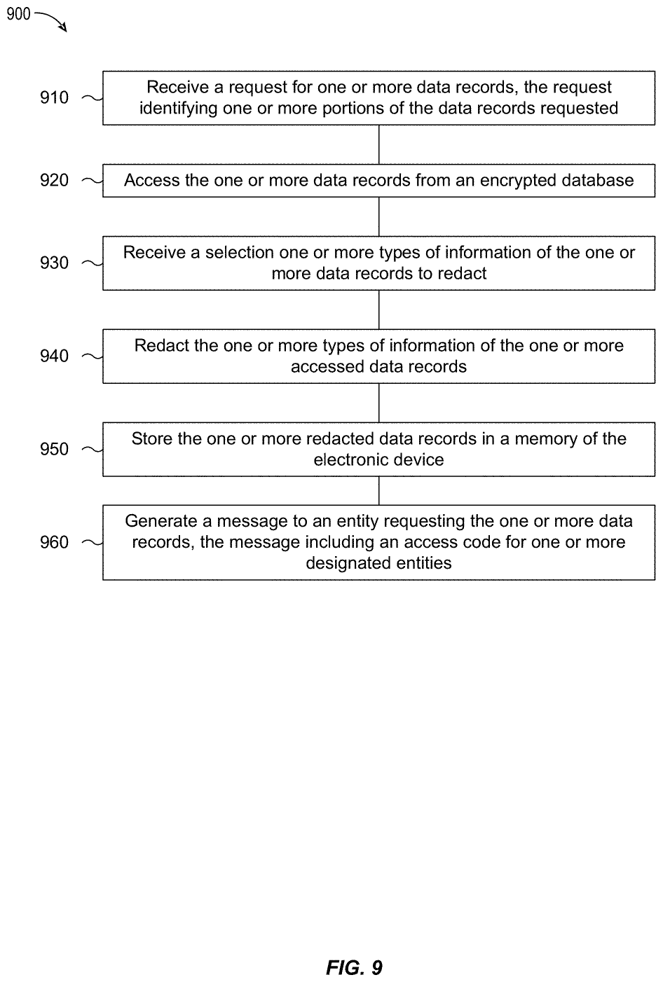

FIG. 9 is a flowchart of an example process 900 associated with techniques for securely sharing access to data records. In some implementations, one or more process blocks of FIG. 9 may be performed by an electronic device (e.g., electronic device 1000). In some implementations, one or more process blocks of FIG. 9 may be performed by another device or a group of devices separate from or including the electronic device. Additionally, or alternatively, one or more process blocks of FIG. 9 may be performed by one or more components of device 1000, such as processor 1018, computer readable medium 1002, Input/ Output subsystem, 1006 and/or wireless circuitry 1008.

As shown in FIG. 9, process 900 may include receiving a request for one or more data records, the request identifying one or more portions of the data records requested (block 910).

For example, the electronic device may receive a request for one or more data records, the request identifying one or more portions of the data records requested, as described above.

As further shown in FIG. 9, process 900 may include accessing the one or more data records from an encrypted database (block 920). For example, the electronic device may access the one or more data records from an encrypted database, as described above.

As further shown in FIG. 9, process 900 may include receiving a selection one or more types of information of the one or more data records to redact (block 930). For example, the electronic device may receive a selection one or more types of information of the one or more data records to redact, as described above.

As further shown in FIG. 9, process 900 may include redacting the one or more types of information of the one or more accessed data records (block 940). For example, the electronic device may redact the one or more types of information of the one or more accessed data records, as described above.

As further shown in FIG. 9, process 900 may include storing the one or more redacted data records in a memory of the electronic device (block 950). For example, the electronic device may store the one or more redacted data records in a memory of the electronic device, as described above.

As further shown in FIG. 9, process 900 may include generating a message to an entity requesting the one or more data records, the message including an access code for one or more designated entities (block 960). For example, the electronic device may generate a message to an entity requesting the one or more data records, the message including an access code for one or more designated entities, as described above.

Process 900 may include additional implementations, such as any single implementation or any combination of implementations described below and/or in connection with one or more other processes described elsewhere herein.

Although FIG. 9 shows example blocks of process 900, in some implementations, process 900 may include additional blocks, fewer blocks, different blocks, or differently arranged blocks than those depicted in FIG. 9. Additionally, or alternatively, two or more of the blocks of process 900 may be performed in parallel.

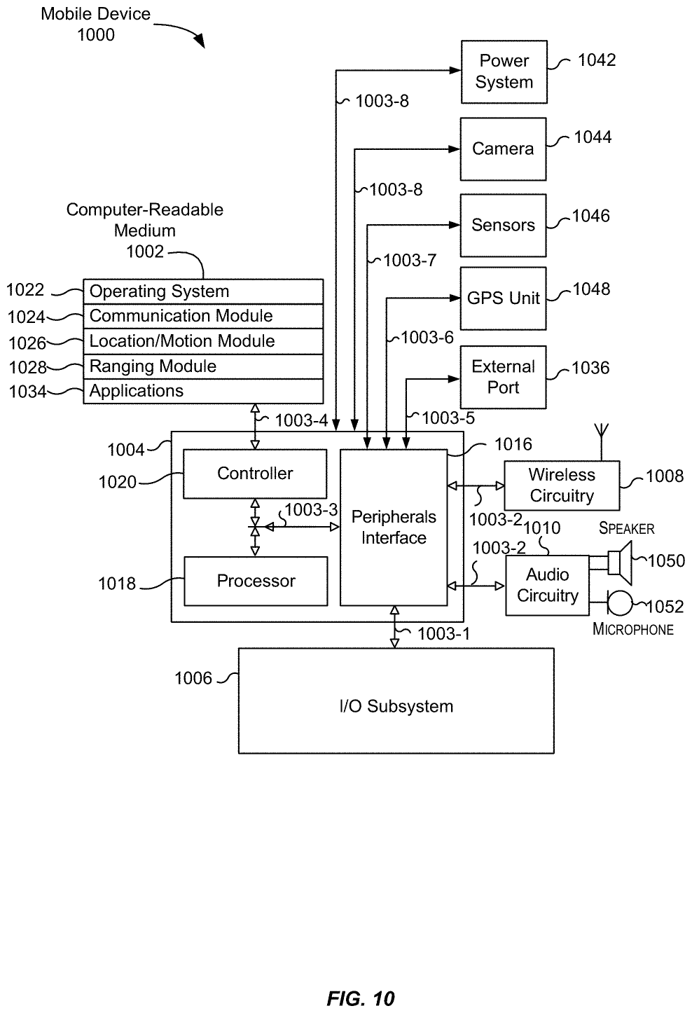

FIG. 10 is a block diagram of an example electronic device 1000. Device 1000 generally includes computer-readable medium 1002, control circuitry 1004, an Input/Output (I/O) subsystem 1006, wireless circuitry 1008, and audio circuitry 1010 including speaker 1050 and microphone 1052. These components may be coupled by one or more communication buses or signal lines 1003. Device 1000 can be any portable electronic device, including a handheld computer, a tablet computer, a mobile phone, laptop computer, tablet device, a smart phone, a portable gaming device, a headset, a wearable device, or the like, including a combination of two or more of these items.

It should be apparent that the architecture shown in FIG. 10 is only one example of an architecture for device 1000, and that device 1000 can have more or fewer components than shown, or a different configuration of components. The various components shown in FIG. 10 can be implemented in hardware, software, or a combination of both hardware and software, including one or more signal processing and/or application specific integrated circuits.

Wireless circuitry 1008 is used to send and receive information over a wireless link or network to one or more other devices' conventional circuitry such as an antenna system, a radio frequency (RF) transceiver, one or more amplifiers, a tuner, one or more oscillators, a digital signal processor, a CODEC chipset, memory, etc. Wireless circuitry 1008 can use various protocols, e.g., as described herein. In various embodiments, wireless circuitry 1008 is capable of establishing and maintaining communications with other devices using one or more communication protocols, including time division multiple access (TDMA), code division multiple access (CDMA), global system for mobile communications (GSM), Enhanced Data GSM Environment (EDGE), wideband code division multiple access (W-CDMA), Long Term Evolution (LTE), Long-term Evolution (LTE)-Advanced, Wi-Fi (such as Institute of Electrical and Electronics Engineers (IEEE) 802.11a, IEEE 802.11b, IEEE 802.11g and/or IEEE 802.11n), Bluetooth, Wi-MAX, voice over Internet Protocol (VoIP), near field communication protocol (NFC), a protocol for email, instant messaging, and/or a short message service (SMS), or any other suitable communication protocol, including communication protocols not yet developed as of the filing date of this document.

Wireless circuitry 1008 is coupled to control circuitry 1004 via peripherals interface 1016. Peripherals interface 1016 can include conventional components for establishing and maintaining communication between peripherals and. Voice and data information received by wireless circuitry 1008 (e.g., in speech recognition or voice command applications) is sent to one or more processors 1018 via peripherals interface 1016. One or more processors 1018 are configurable to process various data formats for one or more application programs 1034 stored on medium 1002.

Peripherals interface 1016 couple the input and output peripherals of device 1000 to the one or more processors 1018 and computer-readable medium 1002. One or more processors 1018 communicate with computer-readable medium 1002 via a controller 1020. Computer-readable medium 1002 can be any device or medium that can store code and/or data for use by one or more processors 1018. Computer-readable medium 1002 can include a memory hierarchy, including cache, main memory, and secondary memory. The memory hierarchy can be implemented using any combination of RAM (e.g., Standard Random Access Memory (SRAM), Dynamic Random Access Memory (DRAM), Double Data Random Access Memory (DDRAM), Read only Memory (ROM), FLASH, magnetic and/or optical storage devices, such as disk drives, magnetic tape, CDs (compact disks) and DVDs (digital video discs). In some embodiments, peripherals interface 1016, one or more processors 1018, and controller 1020 can be implemented on a single chip, such as control circuitry 1004. In some other embodiments, they can be implemented on separate chips.

Processor(s) 1018 can include hardware and/or software elements that perform one or more processing functions, such as mathematical operations, logical operations, data manipulation operations, data transfer operations, controlling the reception of user input, controlling output of information to users, or the like. Processor(s) 1018 can be embodied as one or more hardware processors, microprocessors, microcontrollers; field programmable gate arrays (FPGAs), application-specified integrated circuits (ASICs), or the like.

Device 1000 may include storage and processing circuitry such as control circuitry 1004. Control circuitry 1004 may include storage such as hard disk drive storage, nonvolatile memory (e.g., flash memory or other electrically-programmable-read-only memory configured to form a solid-state drive), volatile memory (e.g., static or dynamic random-access-memory), etc. Processing circuitry in control circuitry 1004 may be used to control the operation of device 1000. This processing circuitry may be based on one or more microprocessors, microcontrollers, digital signal processors, baseband processor integrated circuits, application specific integrated circuits, etc.

Control circuitry 1004 may be used to run software on device 1000, such as internet browsing applications, voice-over-internet-protocol (VOIP) telephone call applications, email applications, media playback applications, operating system functions, etc. To support interactions with external equipment, control circuitry 1004 may be used in implementing communications protocols. Communications protocols that may be implemented using control circuitry 1004 include internet protocols, wireless local area network protocols (e.g., IEEE 802.11 protocols—sometimes referred to as Wi-Fi®), protocols for other short-range wireless communications links such as the Bluetooth® protocol, cellular telephone protocols, multiple-input and multiple-output (MIMO) protocols, antenna diversity protocols, satellite navigation system protocols, millimeter wave communications protocols, IEEE 802.15.4 ultra-wideband communications protocols, etc.

Device 1000 may include input-output circuitry 1006. Input-output circuitry 1006 may include input-output devices. Input-output devices may be used to allow data to be supplied to device 1000 and to allow data to be provided from device 1000 to external devices. Input-output devices may include user interface devices, data port devices, and other input-output components. For example, input-output devices may include one or more displays (e.g., touch screens or displays without touch sensor capabilities), one or more image sensors 1044 (e.g., digital image sensors), motion sensors, and speakers 1050. Input-output device may also include buttons, joysticks, scrolling wheels, touch pads, key pads, keyboards, microphones 1052, haptic elements such as vibrators and actuators, status indicators, light sources, audio jacks and other audio port components, digital data port devices, light sensors, capacitance sensors, proximity sensors (e.g., a capacitive proximity sensor and/or an infrared proximity sensor), magnetic sensors, and other sensors and input-output components.

Device 1000 also includes a power system 1042 for powering the various hardware components. Power system 1042 can include a power management system, one or more power sources (e.g., battery, alternating current (AC)), a recharging system, a power failure detection circuit, a power converter or inverter, a power status indicator (e.g., a light emitting diode (LED)) and any other components typically associated with the generation, management and distribution of power in mobile devices.

In some embodiments, device 1000 includes an image sensor 1044 (e.g., a camera). In some embodiments, device 1000 includes sensors 1046. Sensors can include accelerometers, compass, gyrometer, pressure sensors, audio sensors, light sensors, barometers, and the like. Sensors 1046 can be used to sense location aspects, such as auditory or light signatures of a location.

In some embodiments, device 1000 can include a GPS receiver, sometimes referred to as a GPS unit 1048. A mobile device can use a satellite navigation system, such as the Global

Positioning System (GPS), to obtain position information, timing information, altitude, or other navigation information. During operation, the GPS unit can receive signals from GPS satellites orbiting the Earth. The GPS unit analyzes the signals to make a transit time and distance estimation. The GPS unit can determine the current position (current location) of the mobile device. Based on these estimations, the mobile device can determine a location fix, altitude, and/or current speed. A location fix can be geographical coordinates such as latitudinal and longitudinal information.

One or more processors 1018 run various software components stored in medium 1002 to perform various functions for device 1000. In some embodiments, the software components include an operating system 1022, a communication module 1024 (or set of instructions), a location module 1026 (or set of instructions), a ranging module 1028 that is used as part of ranging operation described herein, and other application programs 1034 (or set of instructions).

Operating system 1022 can be any suitable operating system, including iOS, Mac OS, Darwin, Quatros Real-Time Operating System (RTXC), LINUX, UNIX, OS X, WINDOWS, or an embedded operating system such as VxWorks. The operating system can include various procedures, sets of instructions, software components, and/or drivers for controlling and managing general system tasks (e.g., memory management, storage device control, power management, etc.) and facilitates communication between various hardware and software components.

Communication module 1024 facilitates communication with other devices over one or more external ports 1036 or via wireless circuitry 1008 and includes various software components for handling data received from wireless circuitry 1008 and/or external port 1036.

External port 1036 (e.g., universal serial bus (USB), FireWire, Lightning connector, 60-pin connector, etc.) is adapted for coupling directly to other devices or indirectly over a network (e.g., the Internet, wireless LAN, etc.).

Location/motion module 1026 can assist in determining the current position (e.g., coordinates or other geographic location identifiers) and motion of device 1000. Modern positioning systems include satellite based positioning systems, such as Global Positioning System (GPS), cellular network positioning based on “cell IDs,” and Wi-Fi positioning technology based on a Wi-Fi networks. GPS also relies on the visibility of multiple satellites to determine a position estimate, which may not be visible (or have weak signals) indoors or in “urban canyons.” In some embodiments, location/motion module 1026 receives data from GPS unit 1048 and analyzes the signals to determine the current position of the mobile device. In some embodiments, location/motion module 1026 can determine a current location using Wi-Fi or cellular location technology. For example, the location of the mobile device can be estimated using knowledge of nearby cell sites and/or Wi-Fi access points with knowledge also of their locations. Information identifying the Wi-Fi or cellular transmitter is received at wireless circuitry 1008 and is passed to location/motion module 1026. In some embodiments, the location module receives the one or more transmitter IDs. In some embodiments, a sequence of transmitter IDs can be compared with a reference database (e.g., Cell ID database, Wi-Fi reference database) that maps or correlates the transmitter IDs to position coordinates of corresponding transmitters, and computes estimated position coordinates for device 1000 based on the position coordinates of the corresponding transmitters. Regardless of the specific location technology used, location/motion module 1026 receives information from which a location fix can be derived, interprets that information, and returns location information, such as geographic coordinates, latitude/longitude, or other location fix data

Ranging module 1028 can send/receive ranging messages to/from an antenna, e.g., connected to wireless circuitry 1008. The messages can be used for various purposes, e.g., to identify a sending antenna of a device, determine timestamps of messages to determine a distance of mobile device 1000 from another device. Ranging module 1028 can exist on various processors of the device, e.g., an always-on processor (AOP), a UWB chip, and/or an application processor. For example, parts of ranging module 1028 can determine a distance on an AOP, and another part of the ranging module can interact with a sharing module, e.g., to display a position of the other device on a screen in order for a user to select the other device to share a data item. Ranging module 1028 can also interact with a reminder module that can provide an alert based on a distance from another mobile device.

Dielectric-filled openings such as plastic-filled openings may be formed in metal portions of housing such as in metal sidewall structures (e.g., to serve as antenna windows and/or to serve as gaps that separate portions of antennas from each other).

Antennas may be mounted in housing. If desired, some of the antennas (e.g., antenna arrays that may implement beam steering, etc.) may be mounted under dielectric portions of device 1000 (e.g., portions of the display cover layer, portions of a plastic antenna window in a metal housing sidewall portion of housing, etc.). With one illustrative configuration, some or all of rear face of device 1000 may be formed from a dielectric. For example, the rear wall of housing may be formed from glass plastic, ceramic, other dielectric. In this type of arrangement, antennas may be mounted within the interior of device 1000 in a location that allows the antennas to transmit and receive antenna signals through the rear wall of device 1000 (and, if desired, through optional dielectric sidewall portions in housing). Antennas may also be formed from metal sidewall structures in housing and may be located in peripheral portions of device 1000.

To avoid disrupting communications when an external object such as a human hand or other body part of a user blocks one or more antennas, antennas may be mounted at multiple locations in housing. Sensor data such as proximity sensor data, real-time antenna impedance measurements, signal quality measurements such as received signal strength information, and other data may be used in determining when one or more antennas is being adversely affected due to the orientation of housing, blockage by a user's hand or other external object, or other environmental factors. Device 1000 can then switch one or more replacement antennas into use in place of the antennas that are being adversely affected.

Antennas may be mounted at the corners of housing, along the peripheral edges of housing, on the rear of housing, under the display cover layer that is used in covering and protecting display on the front of device 1000 (e.g., a glass cover layer, a sapphire cover layer, a plastic cover layer, other dielectric cover layer structures, etc.), under a dielectric window on a rear face of housing or the edge of housing, under a dielectric rear wall of housing, or elsewhere in device 1000. As an example, antennas may be mounted at one or both ends of device 1000 (e.g., along the upper and lower edges of housing, at the corners of housing, etc.).

Antennas in device 1000 may include cellular telephone antennas, wireless local area network antennas (e.g., Wi-Fi® antennas at 2.4 GHz and 5 GHz and other suitable wireless local area network antennas), satellite navigation system signals, and near-field communications antennas. The antennas may also include antennas that support IEEE 802.15.4 ultra-wideband communications protocols and/or antennas for handling millimeter wave communications. For example, the antennas may include two or more ultra-wideband frequency antennas and/or millimeter wave phased antenna arrays. Millimeter wave communications, which are sometimes referred to as extremely high frequency (EHF) communications, involve signals at 60 GHz or other frequencies between about 10 GHz and 400 GHz.

Wireless circuitry in device 1000 may support communications using the IEEE 802.15.4 ultra-wideband protocol. In an IEEE 802.15.4 system, a pair of devices may exchange wireless time stamped messages. Time stamps in the messages may be analyzed to determine the time of flight of the messages and thereby determine the distance (range) between the devices.

Image sensors 1044 may include one or more visible digital image sensors (visible-light cameras) and/or one or more infrared digital image sensors (infrared-light cameras). Image sensors 1044 may, if desired, be used to measure distances. For example, an infrared time-of-flight image sensor may be used to measure the time that it takes for an infrared light pulse to reflect back from objects in the vicinity of device 1000, which may in turn be used to determine the distance to those objects. Visible imaging systems such as a front and/or rear-facing camera in device 1000 may also be used to determine the position of objects in the environment. For example, control circuitry 1004 may use image sensors 1044 to perform simultaneous localization and mapping (SLAM). SLAM refers to the process of using images to determine the position of objections in the environment while also constructing a representation of the imaged environment. Visual SLAM techniques include detecting and tracking certain features in images such as edges, textures, room corners, window corners, door corners, faces, sidewalk edges, street edges, building edges, tree trunks, and other prominent features. Control circuitry 1004 may rely entirely upon image sensors 1044 to perform simultaneous localization and mapping, or control circuitry 1004 may synthesize image data with range data from one or more distance sensors (e.g., light-based proximity sensors). If desired, control circuitry 1004 may use display to display a visual representation of the mapped environment.

Input-output devices may include motion sensor circuitry 1046. Motion sensor circuitry 1046 may include one or more accelerometers (e.g., accelerometers that measure acceleration along one, two, or three axes), gyroscopes, barometers, magnetic sensors (e.g., compasses), image sensors (e.g., image sensor 1044) and other sensor structures. Sensors 1046 may, for example, include one or more microelectromechanical systems (MEMS) sensors (e.g., accelerometers, gyroscopes, microphones, force sensors, pressure sensors, capacitive sensors, or any other suitable type of sensor formed using microelectromechanical systems technology).

Control circuitry 1004 may be used to store and process motion sensor data. If desired, motion sensors, processing circuitry, and storage that form motion sensor circuitry may form part of a system-on-chip integrated circuit (as an example).

Input-output devices may include movement generation circuitry. Movement generation circuitry may receive control signals from control circuitry 1004. Movement generation circuitry may include electromechanical actuator circuitry that, when driven, moves device 1000 in one or more directions. For example, movement generation circuitry may laterally move device 1000 and/or may rotate device 1000 around one or more axes of rotation. Movement generation circuitry may, for example, include one or more actuators formed at one or more locations of device 1000. When driven by a motion control signal, actuators may move (e.g., vibrate, pulse, tilt, push, pull, rotate, etc.) to cause device 1000 to move or rotate in one or more directions. The movement may be slight (e.g., not noticeable or barely noticeable to a user of device 1000), or the movement may be substantial. Actuators may be based on one or more vibrators, motors, solenoids, piezoelectric actuators, speaker coils, or any other desired device capable of mechanically (physically) moving device 1000.

Some or all of movement generation circuitry such as actuators may be used to perform operations that are unrelated to rotation of device 1000. For example, actuators may include vibrators that are actuated to issue a haptic alert or notification to a user of device 1000. Such alerts may include, for example, a received text message alert identifying that device 1000 has received a text message, a received telephone call alert, a received email alert, an alarm notification alert, a calendar notification alert, or any other desired notification. By actuating actuator, device 1000 may inform the user of any desired device condition.

Motion sensor circuitry may sense motion of device 1000 that is generated by movement generation circuitry. If desired, motion sensor circuitry may provide feedback signals associated with the sensed motion of device 1000 to movement generation circuitry. Movement generation circuitry may use the feedback signals to control actuation of the movement generation circuitry.

Control circuitry 1004 may use motion sensor circuitry and/or movement generation circuitry to determine the angle of arrival of wireless signals received by device 1000 from another electronic device. For example, control circuitry 1004 may use movement generation circuitry to move device 1000 from one position to another. Motion sensor circuitry may be used to track the movement of device 1000 as it is moved between the different positions. At each position, control circuitry 1004 may receive wireless signals from another electronic device. Control circuitry 1004 may process the received wireless signals together with the motion data from motion sensor circuitry to more accurately determine the position of the other electronic device. The use of motion generation circuitry is merely illustrative, however. If desired, motion sensor circuitry may track movement of device 1000 that is not caused by motion generation circuitry. This may include a user's natural, unprompted movement of device 1000 and/or the user's movement of device 1000 after the user is prompted (by display, audio circuitry 1010, a haptic output device in device 1000, or any other suitable output device) to move device 1000 in a particular fashion.

Other sensors that may be included in input-output devices include ambient light sensors for gathering information on ambient light levels, proximity sensor components (e.g., light-based proximity sensors, capacitive proximity sensors, and/or proximity sensors based on other structures), depth sensors (e.g., structured light depth sensors that emit beams of light in a grid, a random dot array, or other pattern, and that have image sensors that generate depth maps based on the resulting spots of light produced on target objects), sensors that gather three-dimensional depth information using a pair of stereoscopic image sensors, LIDAR (light detection and ranging) sensors, radar sensors, and other suitable sensors.

Input-output circuitry may include wireless communications circuitry for communicating wirelessly with external equipment. Wireless communications circuitry may include radio frequency (RF) transceiver circuitry formed from one or more integrated circuits, power amplifier circuitry, low-noise input amplifiers, passive RF components, one or more antennas, transmission lines, and other circuitry for handling RF wireless signals. Wireless signals can also be sent using light (e.g., using infrared communications).

Wireless communications circuitry 1008 may include radio-frequency transceiver circuitry for handling various radio-frequency communications bands. For example, circuitry 1008 may include transceiver circuitry.

Transceiver circuitry may be wireless local area network transceiver circuitry. Transceiver circuitry may handle 2.4 GHz and 5 GHz bands for Wi-Fi® (IEEE 802.11) communications and may handle the 2.4 GHz Bluetooth® communications band.

Circuitry may use cellular telephone transceiver circuitry for handling wireless communications in frequency ranges such as a communications band from 700 to 960 MHz, a band from 1710 to 10170 MHz, a band from 10300 to 10700 MHz, other bands between 700 and 10700 MHz, higher bands such as LTE bands 42 and 43 (3.4-3.6 GHz), or other cellular telephone communications bands. Circuitry may handle voice data and non-voice data.

Millimeter wave transceiver circuitry (sometimes referred to as extremely high frequency transceiver circuitry) may support communications at extremely high frequencies (e.g., millimeter wave frequencies such as extremely high frequencies of 10 GHz to 400 GHz or other millimeter wave frequencies). For example, circuitry may support IEEE 802.11ad communications at 60 GHz. Circuitry may be formed from one or more integrated circuits (e.g., multiple integrated circuits mounted on a common printed circuit in a system-in-package device, one or more integrated circuits mounted on different substrates, etc.).

Ultra-wideband transceiver circuitry may support communications using the IEEE 802.15.4 protocol and/or other wireless communications protocols. Ultra-wideband wireless signals may be characterized by bandwidths greater than 500 MHz or bandwidths exceeding 20% of the center frequency of radiation. The presence of lower frequencies in the baseband may allow ultra-wideband signals to penetrate through objects such as walls. Transceiver circuitry may operate in a 2.4 GHz frequency band, a 6.5 GHz frequency band, an 8 GHz frequency band, and/or at other suitable frequencies.

Wireless communications circuitry may include satellite navigation system circuitry such as Global Positioning System (GPS) receiver circuitry for receiving GPS signals at 1575 MHz or for handling other satellite positioning data (e.g., GLONASS signals at 1609 MHz). Satellite navigation system signals for receiver are received from a constellation of satellites orbiting the earth.

In satellite navigation system links, cellular telephone links, and other long-range links, wireless signals are typically used to convey data over thousands of feet or miles. In Wi-Fi® and Bluetooth® links at 2.4 and 5 GHz and other short-range wireless links, wireless signals are typically used to convey data over tens or hundreds of feet. Extremely high frequency (EHF) wireless transceiver circuitry may convey signals over these short distances that travel between transmitter and receiver over a line-of-sight path. To enhance signal reception for millimeter wave communications, phased antenna arrays and beam steering techniques may be used (e.g., schemes in which antenna signal phase and/or magnitude for each antenna in an array is adjusted to perform beam steering). Antenna diversity schemes may also be used to ensure that the antennas that have become blocked or that are otherwise degraded due to the operating environment of device 1000 can be switched out of use and higher-performing antennas used in their place.

Wireless communications circuitry can include circuitry for other short-range and long-range wireless links if desired. For example, wireless communications circuitry 36 may include circuitry for receiving television and radio signals, paging system transceivers, near field communications (NFC) circuitry, etc.

The one or more applications 1034 on device 1000 can include any applications installed on the device 1000, including without limitation, a browser, address book, contact list, email, instant messaging, social networking, word processing, keyboard emulation, widgets, JAVA-enabled applications, encryption, digital rights management, voice recognition, voice replication, a music player (which plays back recorded music stored in one or more files, such as MP3 or advanced audio codec (AAC) files), etc.

There may be other modules or sets of instructions (not shown), such as a graphics module, a time module, etc. For example, the graphics module can include various conventional software components for rendering, animating and displaying graphical objects (including without limitation text, web pages, icons, digital images, animations, and the like) on a display surface. In another example, a timer module can be a software timer. The timer module can also be implemented in hardware. The time module can maintain various timers for any number of events.

I/O subsystem 1006 can be coupled to a display system (not shown), which can be a touch-sensitive display. The display displays visual output to the user in a GUI. The visual output can include text, graphics, video, and any combination thereof. Some or all of the visual output can correspond to user-interface objects. A display can use LED (light emitting diode), LCD (liquid crystal display) technology, or LPD (light emitting polymer display) technology, although other display technologies can be used in other embodiments.

In some embodiments, I/O subsystem 1006 can include a display and user input devices such as a keyboard, mouse, and/or trackpad. In some embodiments, I/O subsystem 1006 can include a touch-sensitive display. A touch-sensitive display can also accept input from the user based at least part on haptic and/or tactile contact. In some embodiments, a touch-sensitive display forms a touch-sensitive surface that accepts user input. The touch-sensitive display/surface (along with any associated modules and/or sets of instructions in computer-readable medium 1002) detects contact (and any movement or release of the contact) on the touch-sensitive display and converts the detected contact into interaction with user-interface objects, such as one or more soft keys, that are displayed on the touch screen when the contact occurs. In some embodiments, a point of contact between the touch-sensitive display and the user corresponds to one or more digits of the user. The user can make contact with the touch-sensitive display using any suitable object or appendage, such as a stylus, pen, finger, and so forth. A touch-sensitive display surface can detect contact and any movement or release thereof using any suitable touch sensitivity technologies, including capacitive, resistive, infrared, and surface acoustic wave technologies, as well as other proximity sensor arrays or other elements for determining one or more points of contact with the touch-sensitive display.

Further, I/O subsystem 1006 can be coupled to one or more other physical control devices (not shown), such as pushbuttons, keys, switches, rocker buttons, dials, slider switches, sticks, LEDs, etc., for controlling or performing various functions, such as power control, speaker volume control, ring tone loudness, keyboard input, scrolling, hold, menu, screen lock, clearing and ending communications and the like. In some embodiments, in addition to the touch screen, device 1000 can include a touchpad (not shown) for activating or deactivating particular functions. In some embodiments, the touchpad is a touch-sensitive area of the device 1000 that, unlike the touch screen, does not display visual output. The touchpad can be a touch-sensitive surface that is separate from the touch-sensitive display or an extension of the touch-sensitive surface formed by the touch-sensitive display.

In some embodiments, some or all of the operations described herein can be performed using an application executing on the user's device. Circuits, logic modules, processors, and/or other components may be configured to perform various operations described herein. Those skilled in the art will appreciate that, depending on implementation, such configuration can be accomplished through design, setup, interconnection, and/or programming of the particular components and that, again depending on implementation, a configured component might or might not be reconfigurable for a different operation. For example, a programmable processor can be configured by providing suitable executable code; a dedicated logic circuit can be configured by suitably connecting logic gates and other circuit elements; and so on.

Any of the software components or functions described in this application may be implemented as software code to be executed by a processor using any suitable computer language such as, for example, Java, C, C++, C#, Objective-C, Swift, or scripting language such as Perl or Python using, for example, conventional or object-oriented techniques. The software code may be stored as a series of instructions or commands on a computer readable medium for storage and/or transmission. A suitable non-transitory computer readable medium can include random access memory (RAM), a read only memory (ROM), a magnetic medium such as a hard-drive or a floppy disk, or an optical medium, such as a compact disk (CD) or DVD (digital versatile disk), flash memory, and the like. The computer readable medium may be any combination of such storage or transmission devices.

Computer programs incorporating various features of the present disclosure may be encoded on various computer readable storage media; suitable media include magnetic disk or tape, optical storage media, such as compact disk (CD) or DVD (digital versatile disk), flash memory, and the like. Computer readable storage media encoded with the program code may be packaged with a compatible device or provided separately from other devices. In addition, program code may be encoded and transmitted via wired optical, and/or wireless networks conforming to a variety of protocols, including the Internet, thereby allowing distribution, e.g., via Internet download. Any such computer readable medium may reside on or within a single computer product (e.g. a solid state drive, a hard drive, a CD, or an entire computer system), and may be present on or within different computer products within a system or network. A computer system may include a monitor, printer, or other suitable display for providing any of the results mentioned herein to a user.

As described above, one aspect of the present technology is the gathering, sharing, and use of data, including an authentication tag and data from which the tag is derived. The present disclosure contemplates that in some instances, this gathered data may include personal information data that uniquely identifies or can be used to contact or locate a specific person. Such personal information data can include demographic data, location-based data, telephone numbers, email addresses, twitter ID's, home addresses, data or records relating to a user's health or level of fitness (e.g., vital signs measurements, medication information, exercise information), date of birth, or any other identifying or personal information.

The present disclosure recognizes that the use of such personal information data, in the present technology, can be used to the benefit of users. For example, the personal information data can be used to authenticate another device, and vice versa to control which devices ranging operations may be performed. Further, other uses for personal information data that benefit the user are also contemplated by the present disclosure. For instance, health and fitness data may be shared to provide insights into a user's general wellness, or may be used as positive feedback to individuals using technology to pursue wellness goals.

Although the present disclosure has been described with respect to specific embodiments, it will be appreciated that the disclosure is intended to cover all modifications and equivalents within the scope of the following claims.

The specification and drawings are, accordingly, to be regarded in an illustrative rather than a restrictive sense. It will, however, be evident that various modifications and changes may be made thereunto without departing from the broader spirit and scope of the disclosure as set forth in the claims.

Other variations are within the spirit of the present disclosure. Thus, while the disclosed techniques are susceptible to various modifications and alternative constructions, certain illustrated embodiments thereof are shown in the drawings and have been described above in detail. It should be understood, however, that there is no intention to limit the disclosure to the specific form or forms disclosed, but on the contrary, the intention is to cover all modifications, alternative constructions and equivalents falling within the spirit and scope of the disclosure, as defined in the appended claims.

The use of the terms “a” and “an” and “the” and similar referents in the context of describing the disclosed embodiments (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. The term “connected” is to be construed as partly or wholly contained within, attached to, or joined together, even if there is something intervening. The phrase “based on” should be understood to be open-ended, and not limiting in any way, and is intended to be interpreted or otherwise read as “based at least in part on,” where appropriate. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of all examples, or exemplary language (e.g., “such as”) provided herein, is intended merely to better illuminate embodiments of the disclosure and does not pose a limitation on the scope of the disclosure unless otherwise claimed. No language in the specification should be construed as indicating any non-claimed element as essential to the practice of the disclosure. The use of “or” is intended to mean an “inclusive or,” and not an “exclusive or” unless specifically indicated to the contrary. Reference to a “first” component does not necessarily require that a second component be provided. Moreover, reference to a “first” or a “second” component does not limit the referenced component to a particular location unless expressly stated. The term “based on” is intended to mean “based at least in part on.”

Disjunctive language such as the phrase “at least one of X, Y, or Z,” unless specifically stated otherwise, is otherwise understood within the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present. Additionally, conjunctive language such as the phrase “at least one of X, Y, and Z,” unless specifically stated otherwise, should also be understood to mean X, Y, Z, or any combination thereof, including “X, Y, and/or Z.”

Preferred embodiments of this disclosure are described herein, including the best mode known to the inventors for carrying out the disclosure. Variations of those preferred embodiments may become apparent to those of ordinary skill in the art upon reading the foregoing description. The inventors expect skilled artisans to employ such variations as appropriate, and the inventors intend for the disclosure to be practiced otherwise than as specifically described herein. Accordingly, this disclosure includes all modifications and equivalents of the subject matter recited in the claims appended hereto as permitted by applicable law. Moreover, any combination of the above-described elements in all possible variations thereof is encompassed by the disclosure unless otherwise indicated herein or otherwise clearly contradicted by context.

All references, including publications, patent applications, and patents, cited herein are hereby incorporated by reference to the same extent as if each reference were individually and specifically indicated to be incorporated by reference and were set forth in its entirety herein.

What is claimed is:

1. A method, performed by a processor on an electronic device, for providing access to secure data records, the method comprising:
receiving a request for one or more data records, the request identifying one or more portions of the data records requested;
accessing the one or more data records from an encrypted database;
receiving a selection one or more types of information of the one or more data records to redact;
redacting the one or more types of information of the one or more accessed data records;
storing the one or more redacted data records in the encrypted database;
generating an access token; and
sending the access token to an entity requesting the one or more data records.

2. The method according to claim 1, further comprising sending a message to the entity requesting the one or more data records, wherein the message includes information on the one or more requested data records.

3. The method according to claim 1, further comprising receiving a designation token to enable access to the one or more data records, the designation token identifying a user with permission to share one or more data records.

4. The method according to claim 1, wherein the access token comprises information to grant access permission to the one or more redacted data records.

5. The method according to claim 1, wherein the access token comprises information to identify the one or more redacted data records.

6. The method according to claim 1, wherein the access token expires after a defined time period.

7. The method according to claim 1, wherein the one or more types of information comprises one or more of: a social security number, a personal cell phone number, a home address, or a personal email address.

8. A method, performed by a processor on an electronic device, for providing access to secure data records, the method comprising:
receiving a request for one or more data records, the request identifying one or more portions of the data records requested;
accessing the one or more data records from an encrypted database;
receiving a selection one or more types of information of the one or more data records to redact;
redacting the one or more types of information of the one or more accessed data records;
storing the one or more redacted data records in a memory of the electronic device; and
generating a message to an entity requesting the one or more data records, the message including the one or more redacted data records.

9. The method according to claim 8, wherein a format of the one or more data records is at least one of: a portable document format, a hypertext markup language format, and a JavaScript Object Notation format.

10. The method according to claim 8, further comprising sending a message to the entity requesting the one or more data records, wherein the message includes information on the one or more requested data records.

11. The method according to claim 8, further comprising receiving a designation token to enable access to the one or more data records, the designation token identifying a user with permission to share one or more data records.

12. The method according to claim 8, wherein the one or more types of information comprises one or more of: a social security number, a personal cell phone number, a home address, or a personal email address.

13. A method, performed by a processor on an electronic device, for providing access to secure data records, the method comprising:
receiving a request for one or more data records, the request identifying one or more portions of the data records requested;
accessing the one or more data records from an encrypted database;
receiving a selection one or more types of information of the one or more data records to redact; and
redacting the one or more types of information of the one or more accessed data records.

14. The method according to claim 13, further comprising storing the one or more redacted data records in a memory of the electronic device;

15. The method according to claim 14, further comprising generating a message to an entity requesting the one or more data records, the message including an access code for one or more designated entities.

16. The method according to claim 15, wherein a format of the one or more data records is at least one of: a portable document format, a hypertext markup language format, and a JavaScript Object Notation format.

17. The method according to claim 15, further comprising sending a message to the entity requesting the one or more data records, wherein the message includes information on the one or more requested data records.

18. The method according to claim 15, further comprising receiving a designation token to enable access to the one or more data records, the designation token identifying a user with permission to share one or more data records.

19. The method according to claim 15, wherein the one or more types of information comprises one or more of: a social security number, a personal cell phone number, a home address, or a personal email address.

20. The method according to claim 15, further comprising storing the one or more redacted data records in the encrypted database.
